(19) United States
(12) Patent Application Publication
(10) Pub. No.: US 2013/0063475 A1
(43) Pub. Date: Mar. 14, 2013

(54) SYSTEM AND METHOD FOR TEXT RENDERING

(71) Applicants: Miles M. Cohen, Seattle, WA (US); Kanwal VedBrat, Bellevue, WA (US); Andrew M. Precious, Duvall, WA (US); Worachai Chaoweeraprasit, Bellevue, WA (US); Niklas E. Borson, Langley, WA (US); Claire M. L. Andrews, Kirkland, WA (US); Dylan M. Deverill, Seattle, WA (US); Blake D. Pelton, Redmond, WA (US); Robert A. Brown, Redmond, WA (US)

(72) Inventors: Miles M. Cohen, Seattle, WA (US); Kanwal VedBrat, Bellevue, WA (US); Andrew M. Precious, Duvall, WA (US); Worachai Chaoweeraprasit, Bellevue, WA (US); Niklas E. Borson, Langley, WA (US); Claire M. L. Andrews, Kirkland, WA (US); Dylan M. Deverill, Seattle, WA (US); Blake D. Pelton, Redmond, WA (US); Robert A. Brown, Redmond, WA (US)

(73) Assignee: Microsoft Corporation, Redmond, WA (US)

(21) Appl. No.: 13/229,037

(22) Filed: Sep. 9, 2011

(51) Int. Cl. G06T 11/60; G09G 5/00

(52) U.S. Cl. 345/611; 345/467

(57) ABSTRACT

A method for text rendering that is well suited for use in a computing device with a high resolution display but a low-power graphics processing unit (GPU). The method may comprise calculating a coverage representation of the text in a format that can be efficiently processed by the GPU. As a result, the GPU may perform anti-aliasing and subsequent operations in the rendering process. Efficient processing may be achieved by providing the coverage representation in a format that allows values associated with pixels to be computed based on a byte-aligned chunk of bits in the coverage representation. Additionally, processing on the chunks may be performed using at least one lookup table. For large filtering kernels used for anti-aliasing, the lookup tables may be partitioned into portions dependent on dynamic text characteristics and those independent of the dynamic text characteristics.

### BACKGROUND

Computers frequently output information to human users in the form of text. Text is made up of strings of characters, which for English text is in form of letters and punctuation marks. Information presented in other languages may use other characters. Though, regardless of how the specific characters are used to represent text, a computer may be configured with a utility that can receive input defining the text to be rendered on a display of the computer and then generate the appropriate control signals to the screen so that the text is appropriately displayed.

Such a rendering process may entail multiple steps. As one step, a coverage representation for the text may be created. This coverage representation may indicate, for a particular string of text to be rendered, relative locations where some part of the text will appear. This coverage representation may be in the form of a bitmap in which each bit that is set indicates a location that is to be shaded in order to display the text.

The coverage representation may be generated by a general purpose processor on the computer. In addition to using information about the outlines of the specific characters to be rendered, the processor may form the coverage representation based on other information. For example, the resolution of the display on which the characters are to be rendered may influence the coverage representation such that text is rendered with less detail on low-resolution displays. As another example, which characters are adjacent to one another may be considered.

The coverage representation may then be used to determine which pixels on a display need to be controlled in order to present the text on the screen. The specific color and intensity of each pixel, which needs to be controlled to represent the text, may be selected in subsequent steps and may take into account factors such as a specified color of the text and a color of a background on which the text is to appear overlaid when displayed.

Humans are sensitive to how text is rendered and presented, and the text rendering utility within a computer may be configured to render text in a way that is visually pleasing to humans. For example, humans are sensitive to how the edges of characters are rendered and do not like viewing or find it difficult to view text for which the characters have blocky and jagged, or “aliased,” edges. Several “anti-aliasing” techniques for making the aliased edges appear more smooth have been proposed.

To support anti-aliasing techniques, the coverage representation may be “overscaled.” An overscaled coverage representation has more values to indicate locations occupied by text than there are pixels on a display screen that will be used to display that text. For example, six bits in an overscaled bitmap may be combined to provide information about one displayed pixel.

Anti-aliasing techniques entail specifying the information that will be used to draw the pixels at the edges of characters in a way that the edges of the characters appear to blend into the background on the display. To make the edges appear to blend into the background, the pixels used to display the edges may be indicated to be partially transparent when blended with the information defining the background. Such an effect may be achieved by specifying a “coverage value” for each pixel based on a proportion of the pixel that falls within the area of character. For example, a pixel that falls completely within the area of a character has a coverage value of 100%. Likewise, a pixel that is completely outside the area of the character has a coverage value of 0%. Pixels along the edge, which would be partially within and partially outside the area of the character, receive coverage values in between 0% to 100%. A coverage value normalized to be a number between 0 and 1, inclusive, is called an “alpha” value.

The coverage value of each pixel may be selected to create the impression of a smooth transition from regions containing edges of characters to background regions. When the edges are presented in this way, the characters appear to have smoother outlines and are more pleasing to a human viewer.

A variation on anti-aliasing techniques that render text to appear as if the edges transition smoothly to the background is known as “sub-pixel” anti-aliasing. In many types of display screens (e.g., a liquid crystal display screen), a pixel includes sub-pixels that operate together to project light from the pixel. Each sub-pixel can emit light of a certain color, such as red, green, or blue. The sub-pixels may be controlled as a group to emit from the pixel light of a specified color with a specified intensity. In sub-pixel anti-aliasing, instead of controlling the sub-pixels as a group, a coverage value is computed for each sub-pixel individually to create a shading effect along the edges of a character that provides edges with a smooth appearance. Because the sub-pixels have finer resolution than the full pixels, the visual appearance of text produced by sub-pixel aliasing techniques may be superior to the visual appearance of text produced by techniques that set the coverage value for each pixel as a whole. CLEARTYPE® text rendering system, available from the Microsoft Corporation of Redmond, Wash., is an example of a text rendering technique that uses sub-pixel anti-aliasing.

In contrast, anti-aliasing techniques in which “coverage” values are set for each pixel as a whole are referred to as grayscale anti-aliasing techniques.

### SUMMARY

Improved text rendering techniques may provide a computing device that is responsive to user input while still providing high quality displays. The techniques, whether used individually or collectively, may enable a Graphics Processing Unit (GPU), even a GPU with a limited instruction set, to perform anti-aliasing and coloring of text, while rendering the text. One such technique may relate to the manner in which a coverage representation of the text is generated. The coverage representation may be byte aligned to the processor that produces the coverage values from the coverage representations. The processor may use data in the coverage representation to retrieve coverage values from a lookup table and use these values to render the text.

In some embodiments, the coverage values in the lookup table may be computed to reflect processing steps, in the rendering process, typically performed after the anti-aliasing step. For example, the values read from the lookup table may be supplied as input to a blending step in the rendering process. Accordingly, the lookup table may be computed with values reflecting corrections to the coverage values based on a color in which the text is to be rendered and/or other factors. In some embodiments, multiple lookup tables may be used, with the first lookup table holding information (e.g., coverage values) that may be used to implement anti-aliasing. The second lookup table may store values to implement steps in the rendering process subsequent to anti-aliasing.

Accordingly, in some embodiments, a method for rendering of text is provided. The method may comprise calculating a coverage representation of the text; determining, with at least one processor, at least one value associated with at least one pixel based at least in part on a chunk of bits in the calculated coverage representation; and rendering the at least one pixel based at least in part on the at least one value, wherein the chunk is byte-aligned to the at least one processor.

In some embodiments, at least one computer-readable storage medium is provided. The at least one computer-readable storage medium may store processor-executable instructions that, when executed by at least one processor, may cause the at least one processor to perform a method comprising calculating an overscaled coverage representation of text, wherein the overscaled coverage representation comprises a four-by-four region of bits associated with at least one pixel; and calculating at least one lookup table based at least in part on the overscaled coverage representation, wherein the at least one lookup table stores a plurality of pixel values.

In some embodiments, a system for text rendering is provided. The system may comprise at least once processor configured to calculate an overscaled coverage representation of the text. The system also may comprise at least one graphical processing unit (GPU) configured to retrieve at least one value associated with at least one pixel from at least one lookup table based at least in part on a chunk of bits in the calculated overscaled coverage representation, and render the at least one pixel based at least in part on the at least one value.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows an exemplary computing environment for rendering text, in accordance with some embodiments of the present disclosure.

FIG. 2 shows a flow chart of an illustrative process for rendering text, in accordance with some embodiments of the present disclosure.

FIG. 3a illustrates an example of a format using which a coverage representation may be stored, in accordance with prior art.

FIG. 3b illustrates an example of a format using which a coverage representation may be stored, in accordance with some embodiments of the present disclosure.

FIG. 4 shows a flow chart of an illustrative process for calculating one or more lookup tables, in accordance with some embodiments of the present disclosure.

FIG. 5 illustrates an example of a format using which a coverage representation may be stored.

FIG. 6 is a block diagram generally illustrating an example of a computer system that may be used in implementing aspects of the present disclosure.

### DETAILED DESCRIPTION

The inventors have recognized and appreciated that improved text rendering techniques may lead users to perceive performance of a computing device more favorably. Such improved text rendering techniques may render text quickly and with high quality, making the computing device appear responsive. The techniques may be adapted for the hardware configurations of computing devices that are popular for users who favor heavy graphical interactions. These computing devices may have high-resolution screens and may include one or more GPUs. Though, the GPUs may support only limited instruction sets, such that they may not be well equipped to perform operations conventionally used in text rendering.

The inventors have recognized and appreciated that providing data, such as an overscaled coverage representation, in chunks to the GPU, such that the chunks are byte-aligned to the GPU, allows the GPU to efficiently access and operate on these data. Providing data to the GPU in this way may obviate the need for the GPU to perform computationally-expensive operations to reorganize the data prior to using it. Accordingly, by structuring anti-aliasing operations, and/or other operations that occur during text rendering, such that they can be efficiently performed in a GPU, the speed with which the text rendering occurs may be increased, making the computing device appear more responsive to a user.

The inventors have also appreciated that on high dot-per-inch (DPI) displays, grayscale rendering (i.e., pixel-level anti-aliasing) techniques may be sufficient to achieve desired text quality. The inventors have also recognized and appreciated that many computing devices comprising or connected to high-DPI displays (e.g., tablet computers) often have “low-end” graphics processing units. Such GPUs, for example, may have less processing power, fewer supported instructions (e.g., no bit arithmetic instructions), and less memory. Accordingly, the inventors have recognized that increased responsiveness may be achieved in such computing devices by providing grayscale rendering techniques that may be efficiently implemented in devices that use such low-end GPUs to perform at least a portion of the text rendering process. Though, it should be recognized that aspects of the present invention described herein are not limited to being used for grayscale rendering and, for example, may be used as part of text rendering techniques that use sub-pixel anti-aliasing.

The inventors have recognized and appreciated that providing byte-aligned data chunks to the GPU may allow the GPU to be used efficiently for text rendering. Moreover, implementing some text rendering operations as table look-ups, using tables that may be generated by a main processor, may allow the GPU to perform multiple steps of the text rendering process, including anti-aliasing.

Accordingly, in some embodiments, data provided to a GPU, as part of a grayscale rendering process, may be organized in chunks that are byte-aligned to the GPU so that the GPU need not incur the computational expense of reorganizing the data provided to the GPU prior to processing the data. In some embodiments, this data may comprise an overscaled coverage representation, which may be a bitmap. As such, the GPU may efficiently perform operations for text rendering, including anti-aliasing and subsequent operations in the rendering process.

Byte alignment refers to the way data is arranged and accessed in computer memory or any other suitable computer readable storage medium. When a processor reads from or writes to a memory address, it may do this in chunks, each chunk containing multiple contiguous bits, where contiguous refers to the order in which the bits are stored. A data chunk that is byte-aligned to a processor may consist of a number of bits that is a multiple of the processor's byte size. For example, if the GPU byte size is 8 bits, the number of bits in a byte-aligned data chunk may be any multiple of eight and, for example, may be eight bits, sixteen bits, thirty-two bits, sixty-four bits, etc. Though, it should be appreciated that the processor's byte size may consist of any suitable number of bits. For instance, the processor's byte size may be any suitable power of two, such as two bits, four bits, eight bits, sixteen bits, etc. It should also be appreciated that the processor may be any suitable processor such as a GPU or a central processing unit (CPU).

Further, a data chunk is byte aligned to a processor if the data chunk is stored in memory in such a way so as to occupy locations from which the processor can read an amount of data of that matches the size of the chunk. This result may be achieved if the data chunk may be stored at a location whose address is equal to some multiple of the processor's byte size. For example, when the processor's byte size is 8 bits, the data to be read may be stored at a location whose address is some multiple of 8. When this is not the case (e.g., the data starts at the 10th bit instead of the 8th bit), the chunk of data may be stored in locations that require the computer to read two 2 bytes (16 bits) and do some calculations to extract the desired 8 bits before that data is available for further processing.

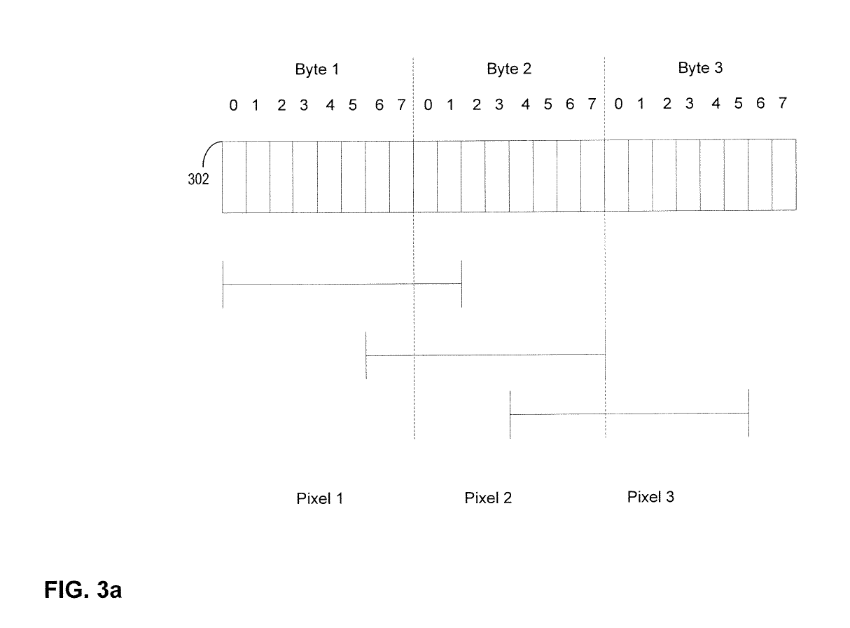

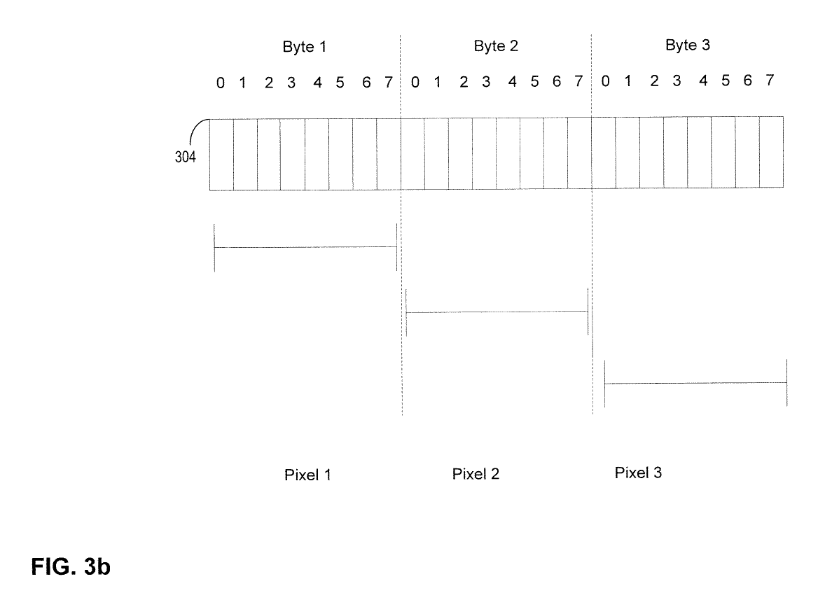

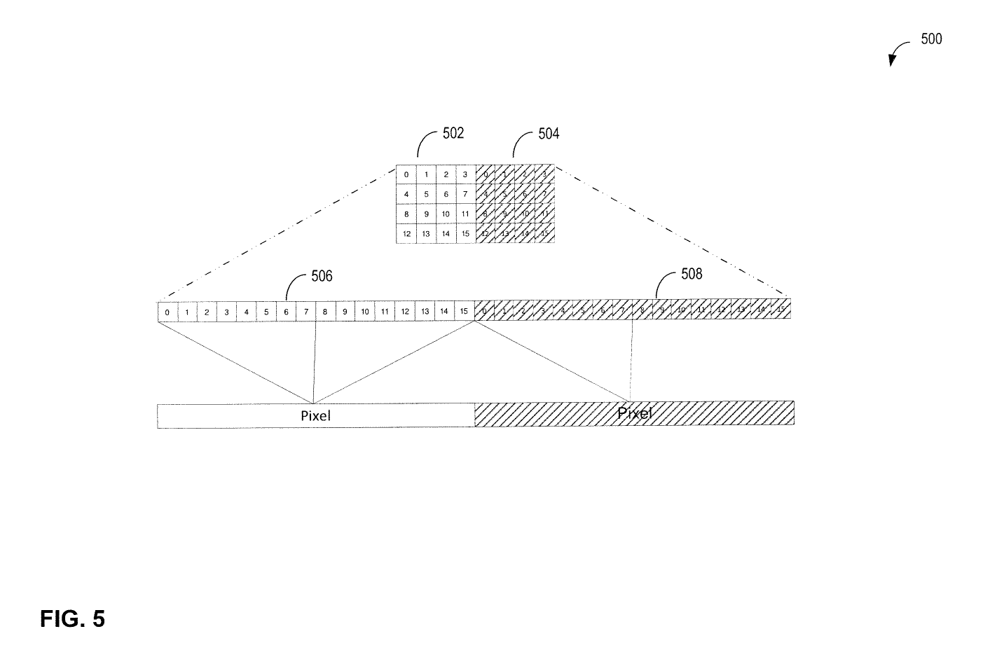

As a specific example, consider a 10-bit data chunk, such as the one illustrated in FIG. 3a. If a processor's byte size is 8 bits, then the data chunk is not byte aligned to that processor because the number of bits is not a multiple of the processor's byte size (since 10 is not a multiple of 8). On the other hand, if the data chunk consists of 16 bits and is stored in two bytes, such a data chunk may be byte aligned to the processor. Further examples are discussed below with reference to FIGS. 3a, 3b, and 5.

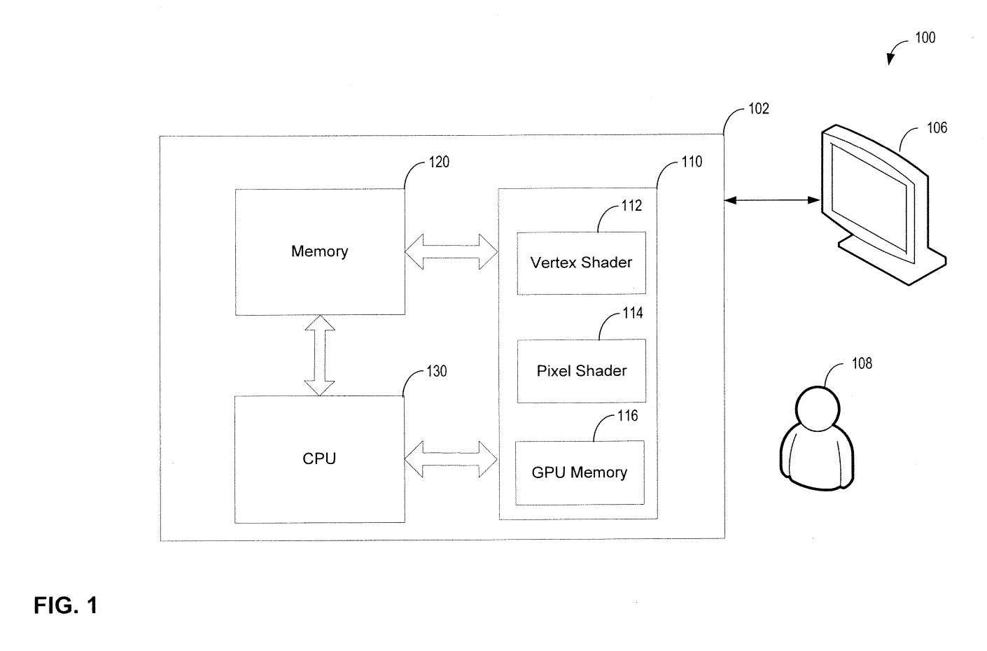

Any suitable computing environment may be used to implement embodiments of the present invention. One such example is illustrated in FIG. 1, which shows an exemplary computing environment 100 for rendering text.

Computing environment 100 includes a computing system 102 operatively coupled to display 106. Computing system 102 may be configured to render text such that the rendered text may be displayed on display 106. In this example, a user (e.g., user 108) may view the rendered text on the display.

Computing system 102 may be configured to render text in any suitable way and using any suitable technique. In some embodiments, computing system 102 may be configured to render text using one or more anti-aliasing techniques. To this end, computing system 102 may use any suitable anti-aliasing technique(s). In some instances, computing system 102 may use grayscale rendering techniques to render text, while, in other instances, computing system 102 may use sub-pixel anti-aliasing techniques or any suitable combination of anti-aliasing techniques to render text. Though, it should be recognized that, in some cases, computing system 102 may not use any anti-aliasing techniques while rendering text.

Computing system 102 may be configured to render text in connection with any suitable purpose. In some embodiments, computing system 102 may be configured to render text for one or more software programs executing, at least in part, on computing system 102. The software programs may comprise any suitable software and, for example, may comprise one or more operating systems and/or one or more software applications. A software application may be any suitable application that may present rendered text to a user and, for example, may be any application comprising a text and/or a graphical user interface. Specific examples of such applications include any text processing application, any command-line application, and any web browsing applications. Many other examples will be apparent to those skilled in the art. Though not expressly illustrated in FIG. 1, computing system 102 may include a text rendering utility that receives input, specifying text to be rendered. Computing system 102 may then apply the text rendering techniques as described herein. Though, it should be appreciated that the specific source of text to be rendered and the specific component of computing system 102 that performs the processing as described herein is not critical to the invention.

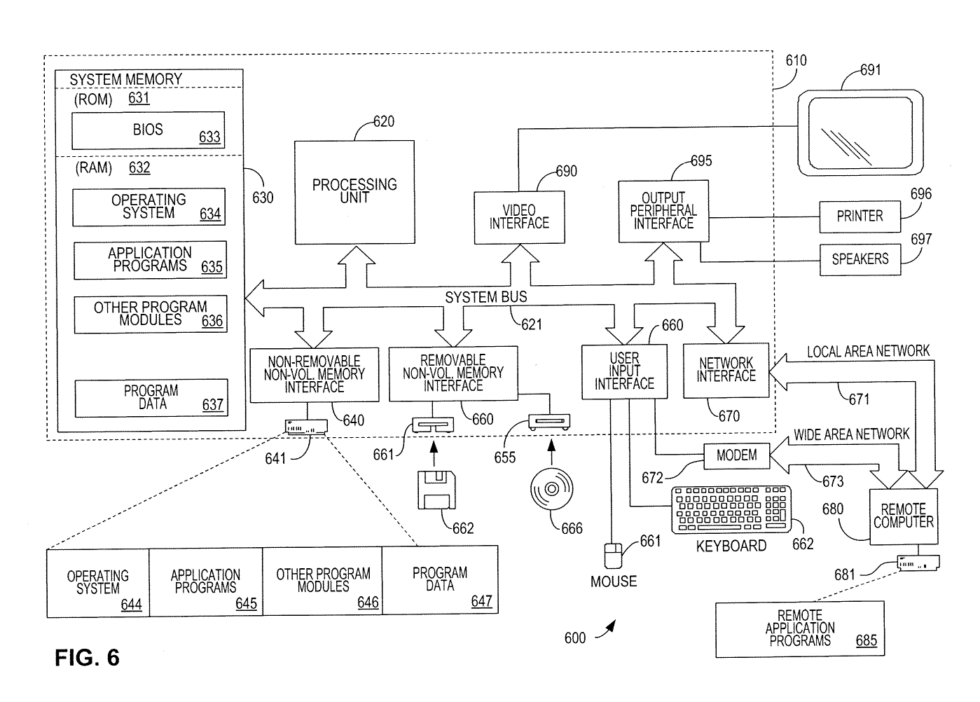

Computing system 102 may be any suitable computing system and may have any suitable form factor. For instance, computing system 102 may be one or more personal computers, one or more servers, one or more laptops, and one or more hand-held devices each of which may be a smartphone, a tablet, a slate, a personal digital assistant, or a text-reader. Other examples of types of computing systems are described in greater detail below with reference to FIG. 6.

Display 106 may be any suitable type of display, may be implemented any suitable technology, and may have any suitable form factor. As such display 106 may be any display configured to display text and/or images. For instance, display 106 may be based on technology related to liquid crystals (e.g., liquid crystal display), cathodoluminescence (e.g., cathode ray tube), or photoluminescence (plasma display).

Display 106 may comprise any suitable number of pixels. The pixels may be spatially arranged in any suitable way. For example, any suitable number of pixels may be spatially arranged within an inch. Accordingly, in some instances, display 106 may have a high number of dots per inch (DPI), which is related to how many pixels may be spatially arranged within an inch. For example, display 106 may have at least 96 DPI, at least 150 DPI, at least 200 DPI, at least 300 DPI, or at least 400 DPI.

Though, in computing environment 100, display 106 is shown as communicatively coupled to computing system 102 via a wired connection, this is not a limitation of the present invention as display 106 may be communicatively coupled to computing system 102 in any suitable way. For example, display 106 may be external to computing system 102 and may be communicatively coupled to computing system 102 via a wired connection, a wireless connection (e.g., a monitor connected by a cable to a desktop computer), or any suitable combination thereof. As another example, display 106 may be integrated with computing system 102 as, for example, the case may be when computing system 102 is a portable computing system such as a laptop or a tablet computer.

Computing system 102 may comprise one or more processors of any suitable type. For instance, computing system 102 may comprise one or more CPUs such as CPU 130. Each of the processors may be able to read data from and write data to a memory such as memory 120. Memory 120 may be any of numerous types of memories including any memory described below with reference to FIG. 6.

In addition, computing system 102 may contain one or more GPUs, such as GPU 110. GPU 110 may be any suitable type of GPU and, as such, may comprise any of numerous components. For example, GPU 110 may comprise one or more shaders, which are processing sub-units of GPU 110 that may be configured to perform operations on data. One example of a shader is a vertex shader, such as vertex shader 112, which may perform computations on streams of vertices. For instance, vertex shader 112 may be configured to calculate values (e.g., positions, colors, and texturing coordinates) associated with individual vertices.

Another example of a shader is a pixel shader, such as pixel shader 114, which may perform computations associated with one or more pixels. The pixel shader may be configured to compute one or more values associated with each pixel. For example, pixel shader 114 may be configured to compute an intensity of light to be projected from each pixel. As another example, pixel shader 114 may be configured to compute a color of light to be projected from each pixel. These values may be computed to represent multiple objects based on the color and coverage values specified for each object. Such blending of objects may be performed using techniques as are known in the art.

In accordance with the techniques described herein, the pixel shader may be configured to compute any suitable intermediate value to determine an intensity and/or a color of light to be projected from each pixel. For example, the pixel shader may be configured to calculate a coverage value associated with a pixel. Though, it should be recognized that the values mentioned above are by way of example only and that a pixel shader may be configured to calculate any suitable values that may be used as part of a text rendering process.

Accordingly, pixel shader 114 may be configured to perform one or more operations by being programmed. This programming may be the result of the configuration of one or more circuits in the GPU 110 or as a result of a computer program loaded into the GPU after its manufacture. To this end, one or more instructions may be provided to the pixel shader that, when executed by GPU 110, cause the pixel shader to perform any suitable function. For instance, downloaded instructions may enable specialized operations to be performed as part of a rendering process.

GPU 110 may access and/or store information in GPU memory, such as GPU memory 116. GPU memory 116 may be any suitable type of memory and may be used by GPU 110 for storing data used in or obtained from various operations. As various rendering operations are performed, the data may be accessed from GPU memory 116, altered, and/or stored in GPU memory 116.

In the illustrated embodiment, GPU memory is shown to be integrated into the same chip as the other components of GPU 110. Such an implementation may allow GPU memory 110 to be a high-speed memory specially adapted for graphics operations. Though, a similar result can be achieved in memory implemented in a separate chip. In some embodiments, GPU 110 may access memory 120 instead of or in addition to GPU memory 116. Though, in other embodiments, for GPU 110 to access data from memory 120, CPU 130 may copy that information to GPU memory 116. Though, it should be recognized that the specific implementation of the GPU memory 116 and the specific mechanism by which CPU 130 and GPU 110 share data is not critical to the invention.

Computing system 102 may be configured to perform any suitable text rendering process. In some embodiments, the components illustrated in FIG. 1 may be commercially available hardware components and the overall system may be configured by programming of CPU 130 and GPU 110. Though, the manner in which the system is configured, and which components of the system are configured to perform each step in the text rendering process is not critical to the invention.

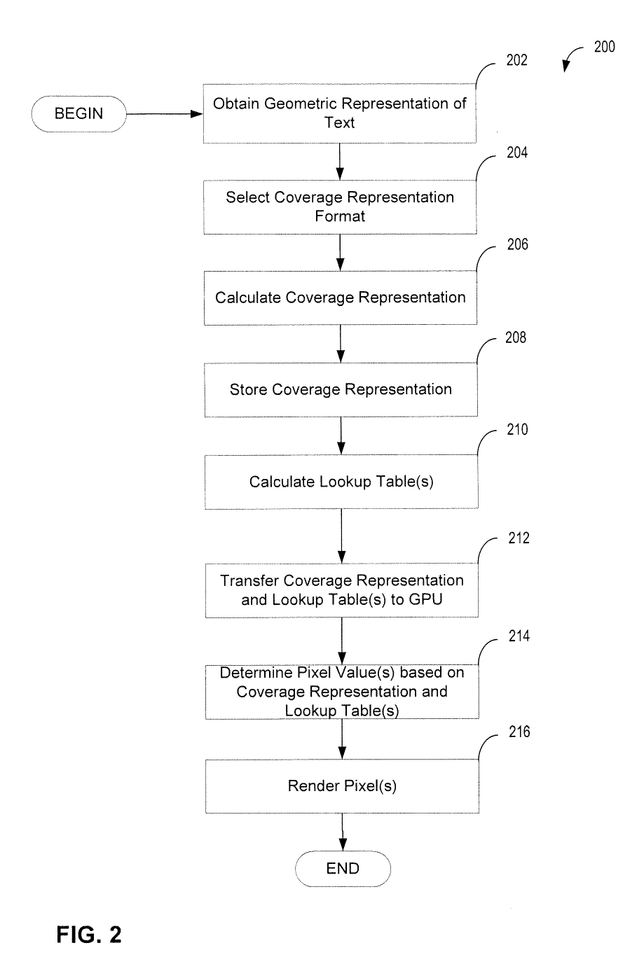

One such process is described with reference to FIG. 2, which is a flow chart of illustrative process 200 for rendering text. In some embodiments, process 200 may be used to perform grayscale text rendering. Though, in other embodiments, process 200 may be used to perform a text rendering process involving sub-pixel anti-aliasing.

Process 200 begins in act 202, where a geometric representation of text may be obtained. A geometric representation of text may be any suitable text representation that delimits the area used to represent one or more text characters. Such a representation may be obtained in any suitable way, including using techniques as are known in the art. For example, a geometric representation may be obtained by combining bitmaps, each representing a character of the text. Though, in other embodiments, the geometric representation may comprise formulas defining the strokes used to make a character or defining the outline of each character.

A geometric representation of text may be obtained from any suitable source. For example, it may be obtained based on a definition of one or more fonts stored in the computer system. Indeed, a font may be a set of geometric representations of each character in that font. These fonts may be stored as part of a software module of an operating system or any other suitable application, such as any of the applications described with reference to computing system 102.

Regardless of how a geometric representation of text may be obtained, process 200 proceeds to acts 204 and 206, where a coverage representation of the text is calculated. A coverage representation of text may comprise information defining a pattern of locations that are occupied by any portion of the text to be rendered. The coverage representation, for example, may be the combination of the geometric representations of all of the characters to be rendered. Though, in some embodiments, the geometric representations of individual characters are adjusted based on factors such as the screen resolution and spacing between characters. Such a computation may be made in any suitable way, including using techniques as are known in the art.

The information that a coverage representation may comprise may depend on the format of the coverage representation. The coverage representation may have any suitable format. In some embodiments, the coverage representation may be a spatially-arranged set of bits—commonly termed a “bitmap.” Each bit may correspond to a location and may have a value indicating whether any portion of the text to be rendered is in that location. The bitmap may comprise any suitable number of bits and may comprise any suitable number of bits for each pixel (or sub-pixel) to be rendered. In some embodiments, the coverage representation may comprise a bit for each pixel (or sub-pixel) on a display on which the text is to be rendered. In this case, the scale or resolution of the coverage representation may be the same as the rendering resolution. It should be noted that this resolution may or may not be the same as the resolution of the display ultimately used to display the text. In other embodiments, the coverage representation may comprise more than one bit for each pixel to be rendered. In this case, the scale or resolution of the coverage representation may be greater than the rendering resolution. In other words, when the coverage representation comprises more than one bit per pixel, such a coverage representation may be used to render text at a higher resolution than the rendering resolution. Accordingly, such a coverage representation is referred to as an overscaled coverage representation and, when the coverage representation is a bitmap, as an overscaled bitmap.

The coverage representation may be overscaled in any suitable way. For example, the coverage representation may be overscaled in one or more directions such as the vertical direction and/or the horizontal direction. Being overscaled in a particular direction implies that the resolution of the coverage representation in that direction may be higher than the rendering resolution in the same direction. As a specific example, suppose that the text to be rendered will be rendered on a portion of a display that occupies 1024 by 968 pixels. A coverage representation overscaled by a factor of two in the horizontal direction may represent this block of text by 2048 by 968 bits, while a coverage representation overscaled by a factor of three in the vertical direction may have a resolution of 1024 by 2904 pixels. A coverage representation overscaled by a factor of two in the horizontal direction and a factor of three in the vertical direction may represent the text by 2048 by 2904 pixels.

An overscaled coverage representation may comprise a predetermined number of bits associated with each pixel. The number of bits may depend on the format of the coverage representation and, in particular, on the way in which the coverage representation may be overscaled. For example, if a coverage representation is overscaled by a factor of m in the horizontal direction and a factor of n in the vertical direction (herein m and n are positive integers each being greater than or equal to 1), the coverage representation may comprise mn bits associated with each pixel. Though, it should be appreciated that number of bits may be determined in other ways. For instance, the number of bits may be any suitable power of two (e.g., four, eight, sixteen, thirty-two, sixty-four, etc.).

Accordingly, to calculate a coverage representation, as part of process 200, a format of the coverage representation may be selected in act 204. Any suitable format may be selected and, in some embodiments, an overscaled format may be selected. In this case, the coverage representation may be overscaled by any suitable factor in any suitable direction. For instance, the amount of overscaling in the horizontal direction may be m, where m may any suitable integer greater than or equal to 1 and the amount of overscaling in the vertical direction may be n, where n may be any suitable integer greater than or equal to 1.

In some embodiments, the product mn may be a multiple of the byte size of a processor. This processor may be any suitable processor and, for example, may be a CPU or a GPU. The processor may perform at least a portion of the operations associated with text rendering and may perform at least a portion of one or more acts of process 200. For instance, the processor may be GPU 110 or CPU 130 described with reference to FIG. 1. Though, in embodiments in which the anti-aliasing is to be applied by a GPU, the product may be selected to be a multiple of the byte size of the GPU. As previously discussed, the processor may have any suitable byte size.

As a specific example, if the processor byte size is 8 bits, then the coverage representation may be overscaled such that the product of the overscaling factors in each direction (i.e., mn) may be any suitable multiple of 8. For example, the coverage representation may be overscaled by a factor of four in each direction—a so-called “four-by-four” format. As another example, the coverage representation may be overscaled only in a horizontal direction by a factor of eight (an eight-by-one format), a factor of sixteen (a sixteen-by-one format) and so on. As yet another example, the coverage representation may be overscaled by a factor of four in the horizontal direction and by a factor of two in the vertical direction (a four-by-two format). As yet another example, the coverage representation may have an eight-by-four format or an eight-by-five format.

It should be appreciated that when the format of a coverage representation is overscaled such that product mn is a multiple of the byte size of a processor, the number of bits associated with each pixel may be a multiple of the byte size of the processor.

Returning to act 204, the coverage representation format may be selected in any suitable way and based on any suitable criterion. For example, the format may be selected based at least in part on the size at which the text should be rendered. In some instances, such as when the size of the font is below a predetermined size threshold, it may be preferable to use a greater amount of horizontal overscaling than vertical overscaling. In such a scenario, an m-by-one format (e.g., an eight-by-one format) may be preferable, with m being any suitable integer greater than or equal to one. In other instances, such as when the size of the font is above a predetermined threshold, it may be preferable to use the same amount of horizontal and vertical overscaling. In such a scenario, an m-by-m format (e.g., a four-by-four format) may be preferable.

It should be appreciated that there are many other examples of criteria that may be used to select a coverage representation format. For example, the format may be selected based at least in part on a characteristic of the display used to display the rendered text. As another example, the format may be selected based at least in part on the font being used to render text. As yet another example, the format may be selected based at least in part on the color of the text. As yet another example, the format may be selected based on the anti-aliasing technique used for rendering the text. In this case, one format may be selected if grayscale rendering is used and another format may be selected if sub-pixel anti-aliasing is used. Still other examples are known in the art.

Regardless of the criteria used to select a coverage representation format, the selection may be expressed in any suitable way. In some embodiments, an application may specify a text rendering option provided by an operating system or other utility. Such a specification may dictate the amount of overscaling to be applied. Though, in other embodiments, a user preference, such as a user preference expressed through user input, may dictate the amount of overscaling to be applied. Such a preference may be expressed directly, or indirectly, such as by specifying a rendering technique or tradeoffs between rendering speed and resolution.

Regardless of what coverage representation format may be selected and how the coverage representation format may be selected, process 200 proceeds to act 206, where the coverage representation is calculated. The coverage representation may be calculated in any suitable way and, for example, may be calculated based at least in part on the selected coverage representation format and the geometric representation of text obtained in act 202 of process 200.

In some embodiments, the coverage representation may be calculated by setting bits in the coverage representation to specific values. For example, each of one or more bits may be set to zero or one based at least in part on the geometric representation of text obtained in act 202. The number of bits used to represent each character may depend on the size with which that character is to be rendered on a display, the resolution of that display, and the amount of overscaling in use. Though, it should be recognized, that these examples are merely illustrative and the number of bits may depend on any suitable factor.

In cases where the coverage representation is not overscaled (one bit per pixel), then the coverage representation may be generated with a bit for each pixel of the display that will be occupied by the text when rendered. In cases where coverage representation is overscaled (more than one bit per pixel), then the coverage representation may be generated with multiple bits for each pixel of the display that will be occupied by the text when rendered, such that the bitmap has a “higher resolution” than the resolution of the display used to render the text. The number of bits in the bitmap per pixel may be determined by the overscaling factor. Though, it should be recognized that the above method is only one approach to calculating a coverage representation and that other alternatives may be used.

As a specific example of the above technique for calculating a coverage representation, consider memory region 502 shown in FIG. 5. Memory region 502 stores a portion of an overscaled coverage representation of text, which has a four-by-four format. Such a coverage representation comprises 16 bits associated with each pixel. For example, the portion stored in memory region 502 consists of 16 bits associated with pixel 0. Each such bit may be thought of as being associated with a higher-resolution representation of the character, sixteen of which occupy an area corresponding to an area of a pixel on the display. Each such bit may be set to one if a corresponding location of the text to be rendered falls within the outline of any character. For instance, if the geometric representation of text to be rendered indicates that, of the bits stored within memory region 502, only bits 7, 10, 11, 13, 14, and 15 fall within an area of the text to be rendered, each of these bits may be set to one. The other bits may be set to 0. Accordingly, in this example, six of the sixteen bits may be set to have the value of 1.

Regardless of how a coverage representation may be calculated, in act 206, process 200 proceeds to act 208, where the calculated coverage representation may be stored. The coverage representation may be stored on any suitable computer readable medium or media. As a specific example, the coverage representation may be stored in any suitable memory such as random-access memory (e.g., memory 120 described with reference to FIG. 1).

Alternatively or additionally, the coverage representation may be stored in GPU memory 116. In some embodiments, the location at which the coverage representation is stored may depend on which component performs the next processing step on the coverage representation. For example, when anti-aliasing is to be subsequently performed by the GPU, the coverage representation may be stored in GPU memory 116. Though, it should be appreciated that the coverage representation may be stored on any of other numerous types of computer readable media including any of those described below with reference to FIG. 6.

Regardless of where a calculated coverage representation may be stored, it should be appreciated that the information in the calculated coverage representation may be organized for storage in any suitable way. In some embodiments, information in the calculated coverage representation may be arranged in a way that depends on the format of the coverage representation. For example, information in the coverage representation may be arranged based at least in part on whether the coverage representation may be overscaled and how it may be overscaled.

In some embodiments, information in the coverage representation may be stored such that data corresponding to a pixel to be rendered will be contiguous in memory and may be read as a data chunk. In some embodiments, the coverage representation may be stored in such a way that information processed for anti-aliasing, whether pixel-level or sub-pixel-level anti-aliasing, may be byte-aligned to the processor performing the anti-aliasing. For example, the coverage representation may comprise a predetermined number of bits associated with a pixel, and those bits may be stored contiguously. As a result, the information may be retrieved from the stored coverage representation in groups of bits that are processed together. Such an organization of the coverage representation in memory may allow faster data access than a conventional approach of storing a bitmap in memory in which the bits are stored in positions determined based on the locations on the display they represent.

For example, the calculated coverage representation may have an m-by-n (e.g., eight-by-one, four-by-four, ten-by-one, and ten-by-five) format and be organized for storage such that mn bits corresponding to amount of information describing the area of a pixel to be rendered on the display are stored contiguously. As one specific example, if the calculated coverage representation has an eight-by-one format, such that eight bits may be associated with each pixel to be rendered, these eight bits may be stored contiguously in a single byte.

As another specific example, the calculated coverage representation may have a four-by-four format such that sixteen bits may be associated with each pixel to be rendered. Using a conventional representation, these sixteen bits may be arranged in a bitmap as a four-by-four region with a layout in the memory that corresponds to the locations that each bit represents. Two such regions, namely regions 502 and 504, are illustrated in FIG. 5. However, if bits are arranged in this way, they may not be stored contiguously. Accordingly, in some embodiments, each of these four-by-four regions of bits may be stored contiguously as two bytes. Specifically, bits in regions 502 and 504 may be stored contiguously in memory regions 506 and 508, respectively.

In some embodiments, a chunk of bits associated with a pixel may be byte-aligned to a processor. As previously described, a data chunk that is byte-aligned to a processor may consist of a number of bits that is a multiple of the processor's byte size. In addition, a data chunk may be byte-aligned to a processor if the data is stored such that it may be addressed at an address equal to some multiple of the processor's byte size. Accordingly, in some embodiments, the scale factors mn and the storage locations of the bits in the coverage representation may be selected to provide byte-aligned values for subsequent steps in the rendering process.

Arranging a coverage representation such that data chunks are byte-aligned may be advantageous for subsequent processing (e.g., reading values from and/or storing values in) the coverage representation by the processor. Consider, for example, a coverage representation having a ten-by-one format such that ten bits are associated with each pixel. If a processor's byte size is 8 bits, then the data chunk is not byte-aligned to that processor because the number of bits is not a multiple of the processor's byte size (since 10 is not a multiple of 8). In turn, this may require that the processor perform expensive bit arithmetic calculations to retrieve the ten bits from the coverage representation.

For instance, as shown in FIG. 3a, byte 1 and byte 2 may be read by the processor and bit arithmetic operations may be performed to access the bits used for processing to derive a value of pixel 1 from the two bytes. Note that even if location 302, which may be the location where the first bit of byte 1 may be stored, were to have an address which may be a multiple of the processor byte size, expensive bit operations may nevertheless be performed to extract the ten bits associated with pixel 1. For a simple GPU that does not support shifting operations, accessing the data used in a subsequent processing step may entail arithmetic operations, which may appear slow to a user waiting for text to be rendered.

In contrast, consider a coverage representation having an eight-by-one format such that it may comprise eight bits associated with each pixel. As shown in FIG. 3b, these bits may be stored in a byte and each such byte may be stored at a location (e.g., byte 1 may be stored at location 304) at an address that may be a multiple of the processor's byte size. In this case, the processor may access bits associated with pixels 1, 2, and 3 directly without performing bit arithmetic operations.

The processor performing subsequent steps in the rendering process may perform that processing in any suitable way. In some embodiments, the processing may be performed using one or more lookup tables. Processing performed in this way may be suitable for performing anti-aliasing, whether pixel-level or sub-pixel-level anti-aliasing, by generating coverage values from a coverage representation. Though, one or more steps in the rendering process following anti-aliasing may also be performed by using one or more lookup tables.

Regardless of how a coverage representation may be stored in act 208, process 200 proceeds to act 210 where one or more lookup tables may be made available for subsequent processing. Each lookup table may be any suitable lookup table and, in some embodiments, may be a lookup table that may store one or more values used in rendering one or more pixels. In some instances, a lookup table may be computed independently of process 200, while in other instances a lookup table may computed as part of process 200.

In some embodiments, information obtained from a coverage representation may be used to look up one or more values stored in a lookup table. As a specific example, each “chunk” of byte-aligned bits may be applied as an index to the lookup table to determine a value generated as a result of one or more processing steps based on the value of the bits of the chunk. For example, a coverage representation may comprise one or more bits in one or more chunks that collectively represent text coverage associated with a pixel, and these bits may be used as an index to retrieve from the lookup table one or more values that may be used in determining values to control the pixel. As a specific example, if the coverage representation has an m-by-n (e.g., eight-by-one or four-by-four) format, the coverage representation may comprise mn (e.g., eight or sixteen) bits associated with each pixel. In this case, mn bits processed together to determine a value of a pixel may be used as an index to retrieve one or more values associated with that pixel from the lookup table.

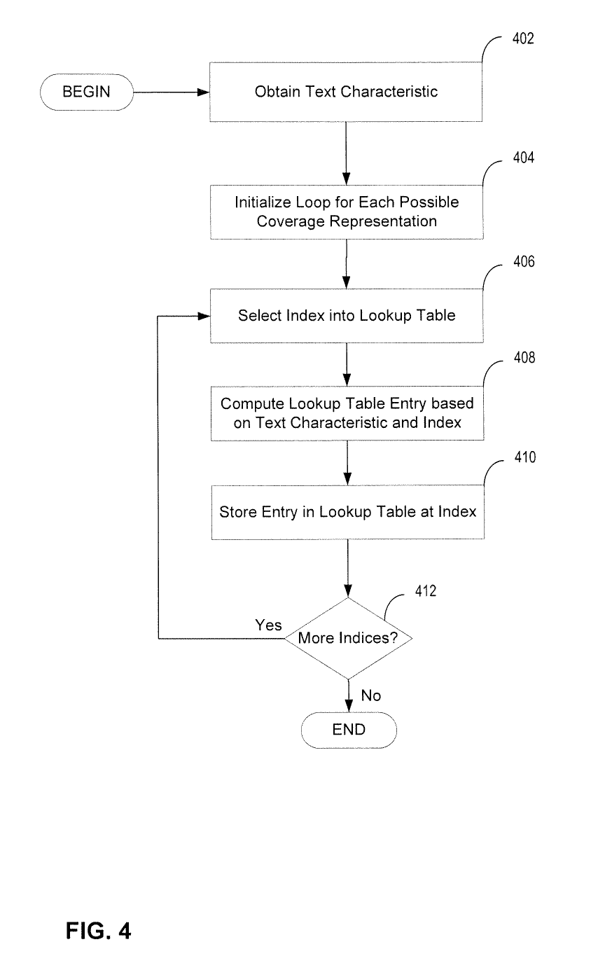

In some embodiments, a lookup table may be calculated based at least in part on the coverage representation and/or a characteristic of the text. For example, information obtained from a coverage representation may be used to calculate one or more values to be stored in a lookup table. The values may be any suitable values and may be associated with one or more pixels (or sub-pixels). For instance, the values may be any of numerous types of values that may be used for rendering one or more pixels (or sub-pixels). Different types of values that may be stored in a lookup table and ways in which these types of values may be calculated are discussed in greater detail below, in part, with reference to FIG. 4.

Regardless of how one or more lookup tables may be calculated in act 210, process 200 proceeds to act 212, where the calculated coverage representation and lookup tables(s) may be transferred to a processor. For example, the coverage representation and lookup table(s) may be transferred to a CPU or to a GPU. In some embodiments, the lookup table may be calculated by the CPU, which may support a richer set of operations, and then transferred to the GPU.

In some embodiments, transferring information to a processor may comprise storing such information at a memory region that the processor may access. The memory region may be any suitable memory region and, for example, may be memory onboard the processor such as an onboard cache. As a specific example, information (e.g., coverage representation and lookup table(s)) may be transferred to a GPU (e.g., GPU 110) by being stored on GPU memory (e.g., 116). Though, it should be recognized that information may be transferred to a processor in any other suitable way.

Next, process 200 proceeds to act 214, where a processor may determine one or more pixel values. The pixel values may be any suitable pixel values and, for example, may be pixel values that may be used to render one or more pixels. In some embodiments, these pixel values may be expressed in a format that defines red, green and blue intensities for a pixel in the display. In this scenario, the pixel values may be stored in a video memory or otherwise applied to control a display. Accordingly, in this scenario, the values calculated for the lookup table represent any values that may be computed as a result of processing in steps of a rendering process from anti-aliasing to generating values that control a pixel on a display.

In other embodiments, the values read from the lookup table may represent values computed as a result of processing in any suitable number of processing steps. Such values may be subsequently processed, possibly using techniques as are known in the art, to complete the rendering process to generate pixel values to control a display. For example, a pixel value determined in act 214 may be a coverage value (or multiple coverage values), either normalized or not, associated with a pixel (or its sub-pixels). Accordingly, it should be appreciated that the information read from the lookup table may represent any suitable characteristic, including, for example, an intensity of light to be generated by a pixel (or a sub-pixel) and/or color to be generated by the pixel. In this case, the information from the lookup table may comprise intensity values for one or more color channels (e.g., red, green, and blue channels).

In some embodiments, these values may be applied to subsequent processing stages in which one or more corrections are applied. For example, it is known that when displayed objects are composited, a gamma correction may be applied to reflect non-linearity of a display. Such a correction may be applied after objects are composited. Though, a correction may be made on the objects individually before compositing using a technique sometimes referred to as “alpha correction.” Accordingly, in some embodiments, a lookup table may store values that have been computed using known techniques to reflect such alpha correction. Accordingly, any of the above-mentioned intensity values may be intensity values that have been alpha-corrected. Though, in some cases, the intensity values may not be alpha corrected, and subsequent processing steps may be performed on the values read from the lookup table. Many other examples of values that may be used by a processor to render pixels will be apparent to those skilled in the art.

Regardless of which pixel values may be determined in act 214, these values may be determined in any suitable way. In some embodiments, a pixel value may be retrieved from one or more lookup tables. For example, the pixel value may be retrieved from the lookup table(s) calculated in act 210 of process 200. The pixel value may be retrieved from the lookup table(s) in any suitable way and, for example, may be retrieved from the lookup table(s) based at least in part on information obtained from the coverage representation.

In some embodiments, a pixel value may be retrieved from the lookup table(s) by using information associated with the pixel and contained in the coverage representation. For instance, a coverage representation may comprise bits associated with the pixel and the pixel value may be retrieved by using the bits as an index into the lookup table(s). Though, in other embodiments a pixel value may be determined in any other suitable way and, for example, may be calculated rather than retrieved from one or more lookup tables.

Next, process 200 proceeds to act 216, where one or more pixels may be rendered. This may be done in any suitable way and, for example, may be done based at least in part on the one or more values determined in act 214. After one or more pixels are rendered, process 200 completes.

It should be recognized that process 200 is illustrative and that many variations of process 200 are possible. For example, though in the illustrated embodiment the coverage representation and the lookup table(s) are calculated, in other embodiments the coverage representation and/or the lookup table(s) may be calculated ahead of time and may be retrieved from storage as part of process 200. As another example, though in the illustrated embodiment the coverage representation is stored, in other embodiments the coverage representation may be transferred directly to a processor, such as a GPU, without being stored.

In other embodiments, however, the processing reflected by the values in the lookup table may depend on information that is available only once other information defining the text to be rendered has been specified. In such a scenario, the lookup tables may be computed as part of the text rendering operation once this information is determined. For example, in some embodiments, the information from the lookup tables corresponds to values computed after alpha correction has been applied. Such alpha correction depends on the color of the text to be rendered, these corrections, and the values in the lookup table that represent them, may not be computed until after color information is determined as part of the rendering process. Nonetheless, by computing the lookup table in a general purpose processor and using it in a GPU, or even in the CPU, to determine values used in rendering multiple pixels, faster rendering may be achieved than if the correction were applied for each pixel in either the general purpose processor or the GPU.

It should be appreciated that, in some embodiments, multiple lookup tables may be used. One or more of the lookup tables may contain information that stores values that depend only on the coverage representation. One or more other tables may store values that depend on color or other information that is not available until the text is rendered. In this scenario, the tables may be computed at different times.

As illustrated, process 200 may comprise calculating one or more lookup tables. In turn, such lookup tables may be used by a processor (e.g., a GPU or a CPU) to determine one or more values that may be used for rendering pixels. FIG. 4 illustrates an exemplary process 400 for calculating a lookup table. In some instances, process 400 may be performed as part of act 210 in process 200, while, in other instances, process 400 may be performed independently of process 200.

Process 400 begins in act 402, where a characteristic of the text to be rendered is obtained. The characteristic may be any suitable characteristic of the text and, for example, may be the color in which the text may be rendered. Though, in embodiments in which anti-aliasing or another processing step depends on characteristics such as font, size or background, the font or size or background color used for rendering the text may be a characteristic obtained at act 402. The text characteristic may be obtained in any suitable way and, for example, may be obtained from any suitable software application.

In some embodiments, the text characteristic may be any suitable text characteristic based at least in part on which the lookup table may be calculated. For example, if values stored in the lookup table are intensity values for each color channel of a pixel, these intensity values may be calculated based on the color of the text. As another example, the format of the coverage representation may depend at least in part on the size and/or font of the text, which in turn may influence how the lookup table is calculated.

Regardless of what text characteristic may be obtained in act 402, if any, one or more lookup tables appropriate for generating values used in rendering text with that characteristic may be generated. Process 400 proceeds to act 404, where a loop may be initialized, the loop being over each possible value a set of bits, in the coverage representation and associated with a pixel, may take on. The range of possible values may depend on the nature of overscaling to be used. Though, the coverage representation may be any suitable coverage representation and, for example, may include as possible values in a range as in the coverage representation calculated in act 206 of process 200.

For example, if the format of the coverage representation is such that mn bits are associated with a pixel (e.g., as may be the case in a coverage representation overscaled in the horizontal direction by a factor of m and in the vertical direction by a factor of n), these mn bits may jointly take 2^{mn} different values and each such value may be used as an index into the lookup table. As such, the size of the lookup table may depend on the format of the coverage representation.

As a specific example of the above, consider a coverage representation having an eight-by-one format. In this case, the bits in the coverage representation associated with a pixel may jointly take on 256 different values. Thus, there may be 256 different indices (e.g., 01001011, 10001110, etc.) that may be used as indices into the lookup table. A value for each such chunk of the coverage representation may be stored in the table. As another example, consider a coverage representation having a four-by-four format. In this case, the bits in the coverage representation associated with a pixel may jointly take on 65,536 (2¹⁶) values. Thus, there may be 65,536 values that may be used as indices into the lookup table. In this case, the lookup table may be stored as a two-dimensional table with the first eight bits of a 16-bit index used to index a row of the two-dimensional table and the last eight bits of the index used to index a column of the two dimensional table.

Next process 400 proceeds to calculate a lookup table in acts 406-412. A lookup table may be a mapping between one or more indices and one or more entries. In particular, an index may be associated with an entry in the lookup table such that the index may be used to retrieve the entry from the lookup table. This mapping may be implemented in any suitable way and, for example, may be implemented by using an index to obtain a memory location from which the entry associated with the index may be retrieved. In some embodiments, the index may identify a memory location at which the entry is stored, while in other embodiments the index may be used to calculate a memory location at which the entry is stored. Accordingly, in act 406, an index into the lookup table may be selected to hold a value associated with the next possible value from the coverage representation.

Regardless of what index may be selected in act 406 or how it may be selected, process 400 proceeds to act 408, where a lookup table entry is calculated. The lookup table entry may comprise any suitable information and, for example, may comprise one or more pixel values. The values in a lookup table entry may be any suitable values and, for example, may be values that a processor may use to render one or more pixels and/or values used in subsequent processing steps to generate values used for rendering one or more pixels.

The manner in which a lookup table entry is calculated may depend in part on the number and type of steps in the rendering process represented by values stored in the lookup table entry. In some embodiments, the lookup table entry may be calculated based at least in part on an index, such as the index obtained in act 406. For example, the lookup table may comprise a coverage value for each possible value that can appear in the chunks of the coverage representation processed concurrently, and thus may be calculated from the index, which in this scenario represents a possible value.

Recall that the bits associated with a pixel in the coverage representation may be used as the index and may be set based on whether the “higher-resolution” pixels associated with each of these bits fall within an area of text to be rendered. As such, these bits may be used to calculate a coverage value associated with the pixel. For example, the coverage value may be calculated based on the proportion of the bits associated with the pixel that are set to one. In the above-mentioned specific example, described with reference to coverage representation portion 502, six out of the sixteen bits are set to one such that the coverage value may be calculated as 37.5%. Though, it should be recognized that the coverage value may be calculated from the index in any of other numerous techniques as known in the art.

In some embodiments, a lookup table entry may comprise values, in addition to or instead of a coverage value, that may be calculated based at least in part on the index, which may represent a possible value of a chunk of the coverage representation. For example, the lookup table entry may comprise values calculated based at least in part on the coverage value, such as may be used in subsequent processing steps.

In some embodiments, a lookup table entry may comprise values that may be calculated based at least in part on the text characteristic obtained in act 402. Any of numerous text characteristics may be used to calculate lookup table entries. For example, if the text characteristic comprises color of the text and the lookup table entry comprises intensity values for each color channel, then such intensity values may be calculated based on the color of the text. In addition, if an alpha correction or other form of correction is applied, the values in the lookup table may be computed using the text characteristics.

Regardless of what value(s) a lookup table entry may comprise and the way in which they were calculated, process 400 proceeds to act 410 where the lookup table entry is stored in the lookup table. The lookup table entry may be stored in any suitable way. For example, the lookup table entry may be stored in association with an index (e.g., index obtained in act 406) such that the lookup table entry may be retrieved by using the index.

After the lookup table entry is stored, process 400 proceeds to decision block 412, where it may be determined whether additional lookup table entries may be computed. This determination may be made in any suitable way and, for example, may be made based at least in part on whether there are more indices for which a lookup table does not yet have an entry. For example, if the lookup table stores entries for a number of indices that is smaller than the total number of possible indices, then it may be determined that additional lookup table entries may be computed. As a specific example, if a coverage representation has an eight-by-one format such that there are 256 different index values and the lookup table has entries for less than 256 different index values, then it may be determined that additional lookup table entries (associated with indices for which there are no lookup table entries) may be computed. Though, it should be recognized that the above example is illustrative and that any other suitable criteria may be used to determine whether additional lookup table entries may be computed.

If it is determined, in decision block 412, that more lookup table entries may need to be computed, process 400 loops back to act 406 and acts 406-412 may be repeated. On the other hand, if it is determined, in decision block 412, that no additional lookup table entries may be computed, process 400 completes.

It should be recognized that process 400 is illustrative and that many variations of process 400 are possible. For example, in the illustrated embodiment only a single lookup table is calculated. However, in other embodiments more than one lookup table may be calculated. The number of lookup tables calculated may be any suitable number and may be selected based at least in part on the number of indices for which a lookup table may need to store an entry. For example, if each index were to comprise 16 bits (as may be the case if a coverage representation were to have a four-by-four format), then there are 2¹⁶ values that an index may take on. In this case, it may be computationally expensive to calculate a single large lookup table with 2¹⁶ entries and, potentially, recalculate the entire lookup table when changes may be needed (e.g., a text characteristic such as color may change).

In embodiments, where more than one lookup table is calculated, each lookup table may store different types of pixel values. In some embodiments, one or more lookup tables may store values that are dependent only upon a value of a chunk from a coverage representation being processed. One more additional lookup tables may store values dependent on characteristics of the text to be rendered. Splitting the lookup tables in this way may reduce the amount of processing that is performed to generate the lookup tables each time text is rendered.

For example, one lookup table may store one or more coverage values, either normalized or not, for each possible index. Another lookup table may store values that may depend on a text characteristic (e.g., color). That table may store, for example, Red, Green, Blue intensity values. The values stored in the second lookup table may be indexed by the coverage values as output by the first table. In this specific example, the values in the second table may represent, for example, R, G, B intensity values as corrected for non-linearity of the display given the desired color, using an alpha correction technique.

In some embodiments, there may be fewer entries in the second table than in the first table because the range of possible values to be used as a second table may be smaller than the range of possible values used to index the first. For example, there may 2¹⁶ possible values for a chunk of the coverage representation that can be an index to the first table. However, if each coverage value is represented in only 8 bits, the index to the second table can take on only 2⁸ possible values, meaning that there are substantially fewer entries in the second table. Accordingly, storing information in this way may be advantageous because if a text characteristic changes, only the second table may be recomputed.

FIG. 6 illustrates an example of a suitable computing system environment 600 on which the invention may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing the invention includes a general purpose computing device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By, way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through anon-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In this example, video interface 690 may include a graphics processing unit. Though, a GPU may be incorporated in any suitable way or, in some embodiments, omitted entirely, with display processing as described herein being performed in one or more processing CPU's. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

For example, in some embodiments, techniques described herein may be applied to text rendering techniques that use pixel-level (i.e., grayscale) anti-aliasing techniques. However, in other embodiments, techniques described herein may be applied to text rendering techniques that use sub-pixel anti-aliasing.

In such embodiments, the coverage representation may store one or more bits associated with each sub-pixel to be rendered. Such data may be organized in any suitable way and, for example, may be byte-aligned to a processor such as the GPU. Furthermore, any lookup tables may store values associated with each sub-pixel to be rendered. As a specific example, a lookup table may store a coverage value, whether normalized or not, associated with each sub-pixel to be rendered. As another specific example, a lookup table may store an intensity value associated with each sub-pixel to be rendered.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for rendering of text, the method comprising:
calculating a coverage representation of the text;
determining, with at least one processor, at least one value associated with at least one pixel based at least in part on a chunk of bits in the calculated coverage representation; and
rendering the at least one pixel based at least in part on the at least one value,
wherein the chunk is byte-aligned to the at least one processor.

2. The method of claim 1, wherein a number of bits in the chunk is a power of two.

3. The method of claim 1, wherein calculating the coverage representation comprises calculating an overscaled bitmap, and the method further comprises:
selecting the format of the overscaled bitmap based at least in part on the size of the text.

4. The method of claim 3, wherein selecting the format of the overscaled bitmap comprises selecting an eight-by-one format or a four-by-four format.

5. The method of claim 3, wherein the overscaled bitmap comprises a predetermined number of bits associated with each pixel.

6. The method of claim 1, wherein determining the at least one value comprises:
retrieving the at least one value from at least one lookup table.

7. The method of claim 6, further comprising:
calculating the at least one lookup table based at least in part on the coverage representation.

8. The method of claim 1, wherein the at least one processor comprises a graphical processing unit coupled to a general purpose processor in a computing device.

9. The method of claim 1, wherein the at least one value associated with the at least one pixel comprises a coverage value.

10. The method of claim 1, wherein the at least one value is derived by application of an anti-aliasing filter.

11. At least one computer-readable storage medium storing processor-executable instructions that, when executed by at least one processor, cause the at least one processor to perform a method comprising:
calculating an overscaled coverage representation of text, wherein the overscaled coverage representation comprises a four-by-four region of bits associated with at least one pixel; and
calculating at least one lookup table based at least in part on the overscaled coverage representation, wherein the at least one lookup table stores a plurality of pixel values.

12. The at least one computer-readable storage medium of claim 13, wherein the four-by-four region of bits is stored as two contiguous bytes.

13. The at least one computer-readable storage medium of claim 11, wherein the at least one lookup table comprises a first lookup table configured to store a plurality of coverage values and a second lookup table, and wherein calculating the at least one lookup table comprises:
calculating at least a plurality of text-color dependent pixel values to store in the second lookup table.

14. The at least one computer-readable storage medium of claim 11, wherein the method further comprises:
using at least one of the plurality of pixel values stored in the at least one lookup table to perform a blending step.

15. A system for rendering of text, the system comprising:
at least one processor configured to:
calculate an overscaled bitmap to represent the text; and
at least one graphical processing unit (GPU) configured to:
retrieve at least one value associated with at least one pixel from at least one lookup table based at least in part on a chunk of bits in the calculated overscaled bitmap, and
render the at least one pixel based at least in part on the at least one value.

16. The system of claim 15, wherein the format of the overscaled bitmap is either an eight-by-one format or a four-by-four format.

17. The system of claim 15, wherein the at least one pixel comprises a first pixel and the GPU is configured to retrieve at least one value associated with the first pixel at a location in the at least one lookup table,
wherein the location depends on data stored in a chunk of bits in the overscaled bitmap associated with the first pixel.

18. The system of claim 15, wherein the GPU does not support bit shifting instructions.

19. The system of claim 15, wherein a number of bits in the chunk is a multiple of the GPU's byte size.

20. The system of claim 15, wherein the at least one processor is configured to perform grayscale rendering.
